(19) United States
(12) Patent Application Publication
(10) Pub. No.: US 2025/0020170 A1
(43) Pub. Date: Jan. 16, 2025

(54) ROLLING BEARING MONITORING DEVICE AND METHOD

(71) Applicant: Aktiebolaget SKF, Göteborg (SE)

(72) Inventor: Sebastian Johannes ZIEGLER, Bamberg (DE)

(21) Appl. No.: 18/760,560

(22) Filed: Jul. 1, 2024

(30) Foreign Application Priority Data
Jul. 11, 2023 (DE) 102023206583.5

(51) Int. Cl. F16C 41/00

(52) U.S. Cl. CPC F16C 41/00; F16C 2233/00

(57) ABSTRACT

A monitoring device (1) for monitoring a rolling bearing (2) being mounted into an application system (4), for example a motor or generator system. The monitoring device (1) includes a sensor unit (12) for monitoring the rolling bearing (2), and a processing unit (14). The sensor unit (12) monitors the rolling bearing (2) for obtaining an actual value of at least one parameter of the rolling bearing (2). The processing unit (14) compares the actual value of the at least one parameter and a desired value of the at least one parameter. The processing unit (14) controls the application system (4) to reduce a deviation between the actual value and the desired value of the at least one parameter.

### CROSS-REFERENCE TO RELATED APPLICATION

This application claims priority to German Application No. 102023206583.5, filed Jul. 11, 2023, the entirety of which is hereby incorporated by reference.

### FIELD

The present disclosure relates to a monitoring device for monitoring a rolling bearing being mounted into an application according to claim 1. Further, the present disclosure relates to a monitoring method for monitoring a rolling bearing being mounted into an application according to claim 9.

### BACKGROUND

In technical applications like generators or motors, rolling bearings may be used for example for supporting a shaft. In current applications, it is known to monitor the rolling bearings for determining a condition of the rolling bearing. Depending on the condition of the rolling bearing, maintenance can be performed, for example replacing the rolling bearing. Further, an indicator indicating the condition of the rolling bearing can be output, for example a green light for a good condition, a yellow light for a condition which might need maintenance in the near future or a red light for immediately needed maintenance.

However, all maintenance actions are done manually. Thus, an operator or diagnostics specialist of the application with the rolling bearing will need to analyze the condition monitoring data and will schedule and plan appropriate maintenance actions or other kind of adjustments to the rolling bearing for improving the rolling bearing condition (for example manual adjustment of the rolling bearing preload).

It is therefore object of the present disclosure to provide an improved way of monitoring a rolling bearing and for performing adjustments of improving the condition of the rolling bearing.

### SUMMARY

This object is solved by a monitoring device for monitoring a rolling bearing according to claim 1 as well as a monitoring method for monitoring a rolling bearing according to claim 9.

The monitoring device is configured to monitor a rolling bearing being mounted into an application system. The application system may be for example a (electric) motor or generator system. The rolling bearing may be used in the application system, for example for supporting a shaft. The application system may also be any other kind of application system which can integrate a rolling bearing.

The monitoring device comprises a sensor unit for monitoring the rolling bearing. The sensor unit may comprise a sensor being arranged in the application system in order to indirectly monitor the rolling bearing. Alternatively, such a sensor may be arranged within the rolling bearing for directly measuring the rolling bearing. The sensor unit is configured to monitor the rolling bearing for obtaining an actual value of at least one parameter of the rolling bearing. The sensor unit may also measure more than one parameter. The parameter is particularly indicative of the actual condition of the rolling bearing.

In order to determine an appropriate approach for improving the condition of the rolling bearing, the monitoring device comprises a processing unit which is configured to compare the actual value of the at least one parameter and a desired value of the at least one parameter. The desired value of the at least one parameter corresponds to a value of the respective parameter in a good condition of the rolling bearing. When the actual value and the desired value differ from each other, the difference indicates that the rolling bearing condition is not in a good or optimal condition and that adjustments may be needed for improving the condition of the rolling bearing. For this reason, the processing unit is further configured to control the application system to reduce a deviation between the actual value and the desired value of the at least one parameter.

This procedure is based on the fact that the application system and the rolling bearing being integrated in the application system influence each other. For example, a high speed of a shaft may lead to a high speed of the rolling bearing, in turn leading to a high temperature of the rolling bearing. Thus, reducing the speed of the shaft of the application system may also reduce the speed of the rolling bearing and may thus also reduce the temperature of the rolling bearing, thus improving the condition of the rolling bearing. As can be seen, when the application system is suitably controlled, the deviation between the actual value and the desired value of the parameter of the rolling bearing may be reduced (for example the deviation between a desired temperature and an actual measured temperature).

As the processing unit may control the application system directly based on the deviation between the actual value and the desired value, no further manual action of an operator or any other person is required. Thus, the condition of a rolling bearing may be easily and fast improved without any manual interaction.

In one embodiment, the deviation between the actual value and the desired value may be output to an operator, for example via an audio or visual signal. Further, also the control of the application system may be output as information to an operator.

According to a further embodiment, the processing unit is configured to automatically select a control command out of a plurality of control commands for controlling the application system, wherein the selected control command is configured to reduce the deviation between the actual value and the desired value of the at least one parameter.

The application system may be controlled via a plurality of control commands. Each control command may be associated with a component of the application system, like a shaft of the application system or a stator or rotor of the application system. Further, each control command may control a specific parameter of the component of the application system. For example, a control command may control the speed of the shaft, a control command may adjust a cooling system of the application system or bearing, adjust a heating system of the application system, limit motor or generator current for reduction of bearing load, operate a break or coupling, operate an actuator at the load side to direct load vector, etc. The cooling system of the application system may also indirectly cool the rolling bearing. For example, heat of the bearing may be transferred to the shaft or housing. The housing may be cooled via water/air, which also cools the bearing. The shaft may be cooled via convection or an oil filling, and the heat is transferred to the air or via oil to the housing.

When the processing unit determines a deviation between the actual value and the desired value, the processing unit may check several available control commands and may then select one of the control commands which is considered to be able to reduce the deviation between the actual value and the desired value. As the processing unit is configured to automatically select the control command, no human, manual interaction is required.

As explained above, according to a further embodiment, the selected control command is configured to control at least one component of the application system for adjustment of the application system. The adjustment of the application system may include an adjustment of a parameter of the rolling bearing, for example an adjustment of the bearing load, the bearing preload, a bearing cooling system and/or an adjustment of other bearing parameters.

As explained above, the application system and the rolling bearing may mutually influence each other. Thus, when adjusting the application system, the rolling bearing may be indirectly adjusted as well. This may be the case for example when the bearing speed needs to be adjusted which may be done via a reduction of the shaft speed when the shaft is supported by the rolling bearing. Further, the rolling bearing may be adjusted directly, for example when adjusting the preload of the rolling bearing. Further, the adjustment of the application system may also include a shutdown of the application system. Such a complete shutdown may be necessary when the deviation between the actual value and the desired value reaches a critical threshold. The critical threshold may be predefined and may correspond to a threshold value which needs immediately action, without the time for any further adjustments. When the processing unit determines that there is no appropriate control command and no appropriate adjustment, the processing unit may inform an operator so that a manual inspection or maintenance may be performed.

According to a further embodiment, the parameter to be adjusted corresponds to the monitored parameter. This may be advantageously as the processing unit can directly derive the control command to be performed as the processing unit has already knowledge about the parameter which needs adjustment.

According to a further embodiment, the sensor unit is configured to monitor at least one of the temperature of the bearing, displacement of an inner and/or an outer ring of the rolling bearing, a speed of the rolling bearing, and a vibration of the rolling bearing. These parameters may be used for determining the appropriate adjustment. For example, when the temperature is too high, the speed of the bearing, for example via the speed of the shaft, may be reduced. When there is a displacement of one of the rings, the preload of the bearing may be adjusted, and so on.

For measuring these parameters, the sensor unit may comprise a temperature sensor, a torque sensor, a vibration sensor, a displacement sensor or any other kind of sensor. The respective sensors may be arranged at suitable positions of the rolling bearing and/or the application system, for example at the shaft or the housing.

According to a further embodiment, the sensor unit is configured to obtain actual values of the at least one parameter of the rolling bearing over time and to send the actual values to the processing unit for comparing the actual values over time with the desired value. This may provide the advantage that small, short deviations, which occur only temporarily, may be ignored. Further, a reduction of the load, speed and/or temperature can lead to longer bearing and component life. A reduction of the speed for a specific application can increase bearing life as lubricant film thickness is maintained and fretting corrosion may be avoided.

According to a further embodiment, the processing unit is configured to determine the status of the application system based on the deviation between the actual value and the desired value. Thus, in addition to determining the status and condition of the rolling bearing, the processing unit may also determine the status of the application system. This knowledge may be used in addition for selecting an appropriate control command.

In the following, an exemplary procedure of monitoring the rolling bearing and corresponding control of the application system is described. As described above, a sensor unit may be used for monitoring the rolling bearing. The rolling bearing as well as sensor(s) of the sensor unit may have unique identifiers. Such unique identifiers may be written on the surface (e.g., in the form of a barcode, data matrix code, serial number) and/or inside (e.g., in a memory).

The sensor(s) collect(s) application relevant data during operation, e.g., temperature of the bearing components (for lubrication optimization and preload optimization), displacement of inner ring and outer ring (preload adjustment, detection of sudden load changes), speed or vibration (condition monitoring of bearing or surrounding components).

The collected data may be sent via an interface (a wired or wireless communication channel) to a server. The server may link the sensor data to the bearing/application by using the unique identifier. A unique dataset is created for each bearing rolling bearing.

The data may be collected over time to create data series which will then be analyzed on the server, by the processing unit. In this case, the processing unit may be implemented on the server. As described above, the processing unit may evaluate the bearing state by comparing the actual value, i.e., the collected data, with the desired value. The result will be an “application statement” like:
a. OK
b. Caution (e.g., sudden load changes, bearing outside of desired preload or temperature range, initial damage to bearing or surrounding components)
c. Not OK (bearing/lubricant experienced overtemperature, bearing or surrounding components damaged)

The processing unit may then determine if the deviation between the actual value and desired value can be reduced by actions such as changing the bearing speed, changing the bearing load, adjusting the preload, adjusting the cooling system. Further actions may include informing the operator or maintenance team or shutting down the application system as described above. The processing unit may be implemented using an algorithm like PID, fuzzy logic or self-learning.

The processing unit may then send a control command (e.g., change speeds, change loads, shutdown, adjust preload etc.) to the application system and/or information to a human interface device (control desk, PC, HUD, tablet, mobile phone) at the operator or maintenance staff. The application system, operator or maintenance staff may act on the control command to ensure that the application state and thus the rolling bearing state moves towards the desired state.

If the bearing needs to be replaced or re-manufactured, the unique identifier may ensure that there is a history of application states saved in the database to give a better insight into the bearing lifecycle. Any maintenance and refurbishment data may be stored in the database as well.

According to a further aspect, a monitoring method for monitoring a rolling bearing being mounted into an application system, for example a motor or generator system, is suggested. The monitoring method comprises monitoring the rolling bearing and obtaining an actual value of at least one parameter of the rolling bearing. The monitoring method further comprises comparing the actual value of the at least one parameter and a desired value of the at least one parameter and controlling the application system to reduce a deviation between the actual value and the desired value of the at least one parameter.

An even further aspect of the present disclosure relates to a computer program product comprising a computer program code which is adapted to prompt a control unit, e.g., a computer, and/or a computer of the above discussed monitoring device to perform the above discussed steps.

The computer program product may be a provided as memory device, such as a memory card, USB stick, CD-ROM, DVD and/or may be a file which may be downloaded from a server, particularly a remote server, in a network. The network may be a wireless communication network for transferring the file with the computer program product.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the present disclosure are described in relation to the drawings, wherein the drawings are exemplarily only, and are not intended to limit the scope of protection. The scope of protection is defined by the accompanied claims, only.

The figures show:

FIG. 1: a schematic block diagram of a monitoring device for monitoring a rolling bearing being mounted into an application system.

FIG. 2: a schematic cross-section of a first embodiment of the application system of FIG. 1; and

FIG. 3: a schematic cross-section of a second embodiment of the application system of FIG. 1.

### DETAILED DESCRIPTION

In the following same or similar functioning elements are indicated with the same reference numerals.

FIG. 1 shows a monitoring device 1 for monitoring a rolling bearing 2 being mounted into an application system 4. In the figures, the rolling bearing 2 is illustrated as a roller bearing having an inner ring 6, an outer ring 8 and rollers 10 being arranged between the inner ring 6 and the outer ring 8. The rolling bearing 2 may also be any other kind of bearing, for example a ball bearing, a tapered roller bearing, a spherical roller bearing or any other kind of bearing, for example also a plain bearing without rolling elements.

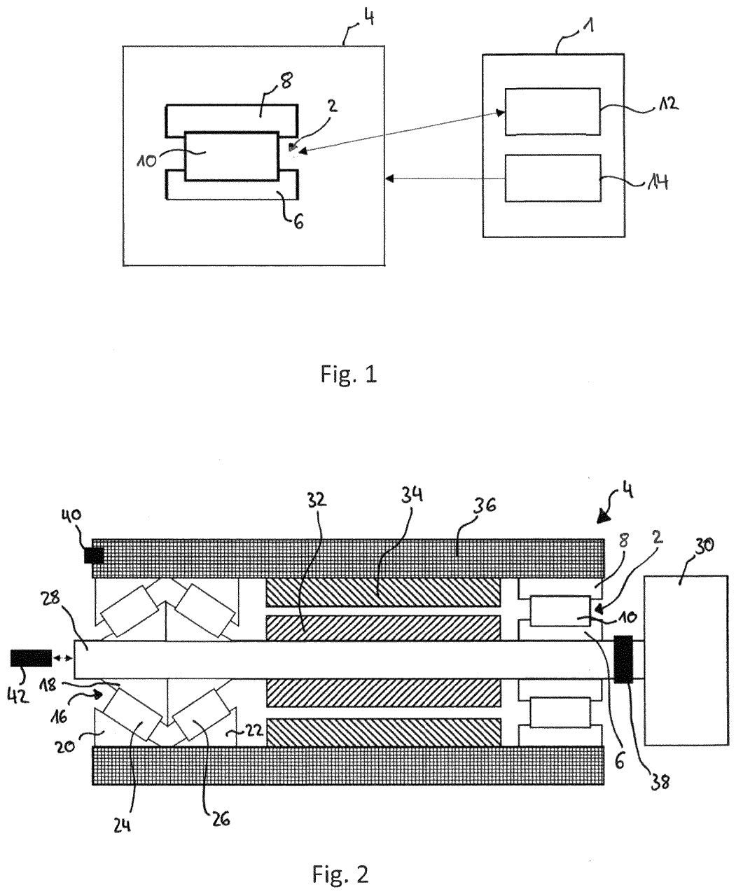

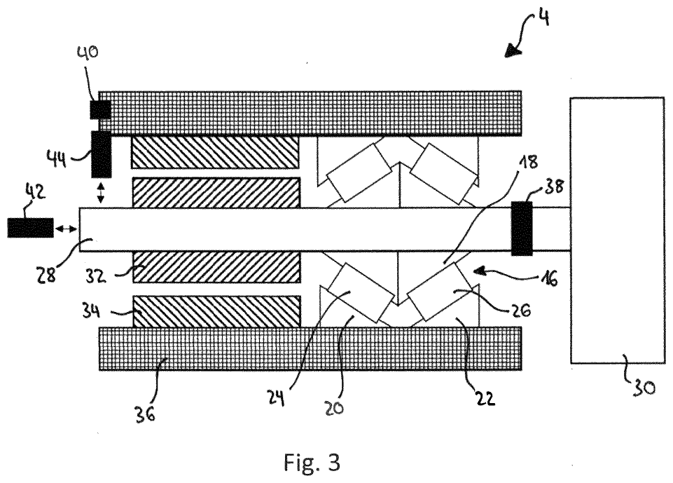

The application system 4 may be for example a motor or generator system, in which a rolling bearing 2 may be installed. For example, the rolling bearing 2 may support a shaft of the application system 4 as will be further explained with respect to FIGS. 2 and 3 below.

The monitoring device 1 comprises a sensor unit 12 for monitoring the rolling bearing 2. The sensor unit 12 may comprise one or more sensors as shown with respect to FIGS. 2 and 3. The sensors may be installed in the application system 4 and/or in the rolling bearing 2. The sensor unit 12 is configured to monitor the rolling bearing 2 for obtaining an actual value of at least one parameter of the rolling bearing 2. The parameters may be for example a temperature of the rolling bearing 2, vibrations of rolling bearing 2 etc.

The monitoring device 1 further comprises a processing unit 14. The processing unit 14 is configured to compare the actual value of the at least one parameter and a desired value of the at least one parameter. Subsequently, the processing unit 14 controls the application system 4 to reduce a deviation between the actual value and the desired value of the at least one parameter.

An exemplary application system 4 is shown in FIG. 2. In this case, the application system 4 comprises the rolling bearing 2 as shown in FIG. 1. The rolling bearing 2 supports a shaft 28 on one axial side. On the other axial side, the shaft 28 is supported by a double row roller bearing 16. The roller bearing 16 comprises an inner ring 18, two outer rings 20, 22 and two rows of rollers 24, 26.

On the side of the rolling bearing 2, the shaft is coupled to a load 30. A rotor 32 is arranged around the shaft 28. The corresponding stator 34 is arranged within a housing 36 of the application system 4. In this embodiment, the bearings 2, 16 are arranged on both axial sides of the rotor-stator arrangement.

In order to monitor parameters of the application system 4 as well as of the bearings 2, 16, several sensors may be arranged within the application system 4, constituting the sensor unit 12. In the application system 4 shown in FIG. 2, a torque sensor 38 is arranged on the shaft 28. The torque sensor 38 may monitor a torque and speed of the shaft 28, and thus also of the inner ring 6 of the bearing 2 and the inner ring 18 of the bearing 16.

Further, a vibration sensor 40 may be attached to the housing 36 and may be used for monitoring vibrations within the application system 4 as well as the bearings 2, 16. Further, a displacement sensor 42 may be arranged near the shaft 28. The displacement sensor 42 may be for example an eddy current sensor which can be used for monitoring a displacement of the shaft 28 and thus also a displacement of the inner rings 6, 18 with respect to the outer rings 8, 20, 22.

As described above, the processing unit 14 may use the monitored parameters for select a control command for adjusting the application system 4. For example, when the torque sensor 38 determines an actual value which deviates from the desired value for the torque of the shaft 28 and thus of the inner rings 6, 18 and thus the bearings 2, 16, the processing unit 14 may control the application system 4 to reduce the torque of the shaft 28. This also reduces the torque of the bearings 2, 16.

In another embodiment of the application system 4 as shown in FIG. 3, only the double row bearing 16 supports the shaft 28. Here, the bearing 16 is arranged between the load 30 and the rotor-stator arrangement 32, 34. In contrast to FIG. 2, an additional displacement sensor 44 is arranged for monitoring a displacement between the housing 36 and the shaft 28. Also in this case, the processing unit 14 may select control commands for adjusting parameters of the application system 4 as described above.

In summary, the described monitoring device provides an improved and easy approach for monitoring a rolling bearing and for improving the condition of the rolling bearing via an adjustment of the corresponding application system. This allows for an automatic control and adjustment of the application system and the rolling bearing, without the need of any human, manual interaction.

### REFERENCE NUMERALS

1 monitoring device
2 rolling bearing
4 application system
6 inner ring
8 outer ring
10 rolling elements
12 sensor unit
14 processing unit
16 roller bearing
18 inner ring
20 outer ring
22 outer ring
24 rollers
26 rollers
28 shaft
30 load
32 rotor
34 stator
36 housing
38 torque sensor
40 vibration sensor
42 displacement sensor
44 displacement sensor

What is claimed is:

1. A monitoring device for monitoring a rolling bearing being mounted into an application system, the monitoring device comprising:
a sensor unit for monitoring the rolling bearing, the sensor unit being configured to monitor the rolling bearing for obtaining an actual value of at least one parameter of the rolling bearing;
a processing unit configured to compare the actual value of the at least one parameter and a desired value of the at least one parameter, the processing unit being configured to control the application system to reduce a deviation between the actual value and the desired value of the at least one parameter.

2. The monitoring device according to claim 1, wherein the processing unit is configured to automatically select a control command out of a plurality of control commands for controlling the application system, wherein the selected control command is configured to reduce the deviation between the actual value and the desired value of the at least one parameter.

3. The monitoring device according to claim 2, wherein the selected control command is configured to control at least one component of the application system for adjustment of the application system.

4. The monitoring device according to claim 2, wherein the adjustment of the application system includes an adjustment of a parameter of the rolling bearing, in particular an adjustment of the bearing speed, the bearing load, the bearing preload, a bearing cooling system and/or an adjustment of other bearing parameters, and/or includes a shutdown of the application system.

5. The monitoring device according to claim 4, wherein the parameter to be adjusted corresponds to the monitored parameter.

6. The monitoring device according to claim 1, wherein the sensor unit is configured to monitor at least one of the temperature of the rolling bearing, displacement of an inner and/or an outer ring of the rolling bearing, a speed of the rolling bearing, and a vibration of the rolling bearing.

7. The monitoring device according to claim 1, wherein the sensor unit is configured to obtain actual values of the at least one parameter of the rolling bearing over time and to send the actual values to the processing unit for comparing the actual values over time with the desired value.

8. The monitoring device according to claim 1, wherein the processing unit is configured to determine the status of the application system based on the deviation between the actual value and the desired value.

9. The monitoring device according to claim 3, wherein the adjustment of the application system includes an adjustment of a parameter of the rolling bearing, in particular an adjustment of the bearing speed, the bearing load, the bearing preload, a bearing cooling system and/or an adjustment of other bearing parameters, and/or includes a shutdown of the application system.

10. The monitoring device according to claim 9, wherein the parameter to be adjusted corresponds to the monitored parameter.

11. The monitoring device according to claim 10, wherein the sensor unit is configured to monitor at least one of the temperature of the rolling bearing, displacement of an inner and/or an outer ring of the rolling bearing, a speed of the rolling bearing, and a vibration of the rolling bearing.

12. The monitoring device according to claim 11, wherein the sensor unit is configured to obtain actual values of the at least one parameter of the rolling bearing over time and to send the actual values to the processing unit for comparing the actual values over time with the desired value.

13. The monitoring device according to claim 12, wherein the processing unit is configured to determine the status of the application system based on the deviation between the actual value and the desired value.

14. A monitoring method for monitoring a rolling bearing being mounted into an application system, the monitoring method comprising:
monitoring the rolling bearing;
obtaining an actual value of at least one parameter of the rolling bearing;
comparing the actual value of the at least one parameter and a desired value of the at least one parameter; and
controlling the application system to reduce a deviation between the actual value and the desired value of the at least one parameter.
